(19) United States
(12) Patent Application Publication
(10) Pub. No.: US 2016/0199885 A1
(43) Pub. Date: Jul. 14, 2016

(54) HONEYCOMB REMOVAL

(71) Applicant: UNITED TECHNOLOGIES CORPORATION, Hartford, CT (US)

(72) Inventors: Clifford V. Mitchell, Cullman, AL (US); Gene D. Hansen, Glastonbury, CT (US); Jeffery W. Shaffer, San Antonio, TX (US)

(21) Appl. No.: 14/910,841

(22) PCT Filed: Aug. 14, 2014
(86) PCT No.: PCT/US14/51091

§ 371 Date: Feb. 8, 2016

Related U.S. Application Data
(60) Provisional application No. 61/865,838, filed on Aug. 14, 2013.

(51) Int. Cl. B08B 3/02

(52) U.S. Cl. CPC B08B 3/02

(57) ABSTRACT

A method is provided for removing metal honeycomb from a substrate. The method includes directing a forced pulse jet of fluid at an angle of attack of between about 70-110 degrees with respect to the substrate. The fluid strikes the substrate at the base of the honeycomb to remove the honeycomb from the substrate, whereby the substrate may be reused.

### CROSS-REFERENCE TO RELATED APPLICATION

This application claims priority to U.S. patent appliation Ser. No. 61/865,838 filed Aug. 14, 2013, which is hereby incorporated herein by reference in its entirety.

### BACKGROUND

The present disclosure relates to removal of honeycomb from a substrate utilizing pulses of fluid.

A honeycomb structure is commonly used to form abradable seals within a gas turbine engine. The honeycomb structure, which is commonly composed of metal alloys, is typically formed with ribbon attached to the component with a braze of metals such as nickel, chrome and various combinations thereof. During operation, rotor blades cut into the honeycomb, such that the honeycomb forms a seal with the tips of the rotor blades. Upon rework of the engine and the various components thereof, the honeycomb and braze are often removed.

Conventionally, honeycomb removal has been accomplished via machining and grinding techniques, chemical immersion, and de-brazing with heat. These techniques may be relatively tedious processes that often may result in irreparable component damage. For example, normal engine operations may result in stators that may not be perfectly round. Rework techniques which fail to account for this irregular shape, often remove part of the substrate which may result in a component unacceptable for further operations.

An effective alternative to chemical and mechanical processes includes high-pressure waterjet systems that strip the honeycomb in an environmentally benign procedure. The high-pressure waterjet systems process is also efficient in terms of cost, removal rates, and less damage to the underlying substrate material. Such systems, however, utilize an extremely high fluid pressure, which results in significant fatigue to the system components.

### SUMMARY

A method for removing honeycomb from a substrate, according to one disclosed non-limiting embodiment of the present disclosure, includes directing a forced pulse jet of fluid to remove the honeycomb from the substrate, whereby the substrate may be reused.

In a further embodiment of the present disclosure, the pressure of the forced pulse jet of fluid is above about 5,000 psi (about 345 bar).

In a further embodiment of any of the foregoing embodiments of the present disclosure, the forced pulse jet of fluid is provided at a volume of about thirteen (13) gallons per minute.

In a further embodiment of any of the foregoing embodiments of the present disclosure, the pressure of the forced pulse jet of fluid is between about 5,000 psi (about 345 bar) to about 15,000 psi (about 1034 bar.

In a further embodiment of any of the foregoing embodiments of the present disclosure, the forced pulse jet of fluid is a non-deionized water.

In a further embodiment of any of the foregoing embodiments of the present disclosure, the forced pulse jet of fluid is directed at an angle of attack of between about ninety (90) degrees +/−forty-five (45) degrees with respect to the substrate.

In a further embodiment of any of the foregoing embodiments of the present disclosure, the forced pulse jet of fluid is directed at an angle of attack of about 90 degrees with respect to the substrate.

A method for removing honeycomb from a substrate, according to another disclosed non-limiting embodiment of the present disclosure, includes directing a forced pulse jet of fluid at an angle of attack of between about ninety (90) degrees +/−forty-five (45) degrees with respect to the substrate. The fluid strikes the substrate at the base of the honeycomb to remove the honeycomb from the substrate, whereby the substrate may be reused.

In a further embodiment of any of the foregoing embodiments of the present disclosure, the forced pulse jet of fluid is directed at an angle of attack of about 90 degrees with respect to the substrate.

In a further embodiment of any of the foregoing embodiments of the present disclosure, the pressure of the forced pulse jet of fluid is above about 5,000 psi (about 345 bar).

In a further embodiment of any of the foregoing embodiments of the present disclosure, the forced pulse jet of fluid is provided at a volume of about thirteen (13) gallons per minute.

In a further embodiment of any of the foregoing embodiments of the present disclosure, the pressure of the forced pulse jet of fluid is between about 5,000 psi (about 345 bar) to about 15,000 psi (about 1034 bar) at a volume of about thirteen (13) gallons per minute

In a further embodiment of any of the foregoing embodiments of the present disclosure, the forced pulse jet of fluid is provided at a volume of about thirteen (13) gallons per minute.

In a further embodiment of any of the foregoing embodiments of the present disclosure, the fluid striking the substrate at the base of the honeycomb operates to at least partially remove a braze from the substrate

In a further embodiment of any of the foregoing embodiments of the present disclosure, the method includes performing multiple passes.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 is a schematic view of a Pulse Jet System;

FIG. 2 is a schematic view of an aerospace component here illustrated as an abradable seal;

FIG. 3 is a representation of removal from a substrate related to a pass; and

FIG. 4 is a schematic view of a pulse jet with respect to a substrate.

### DETAILED DESCRIPTION

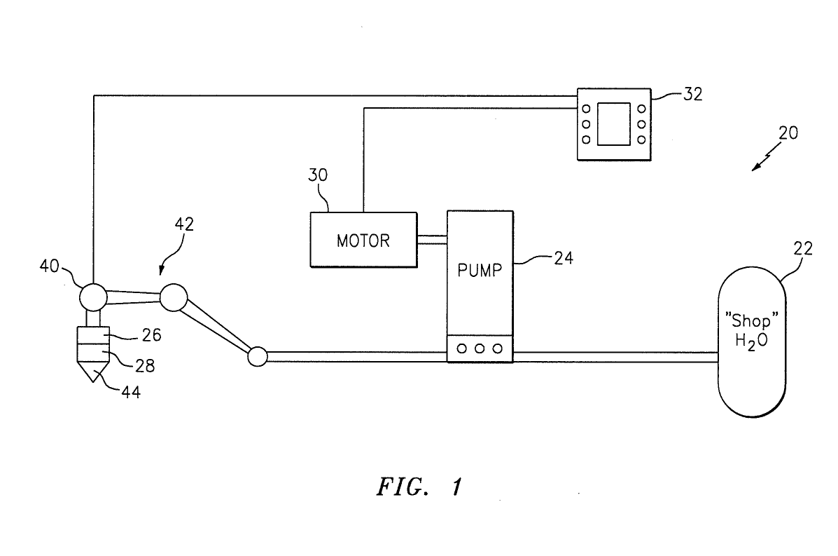

FIG. 1 schematically illustrates a pulse jet system 20. The system 20 generally includes a fluid supply 22, a pump 24, an ultrasonic transducer 26, a nozzle 28, an electric motor 30 and a control 32 which are the primary components of the PurePulse™ waterjet technology from Pratt & Whitney Automation, Inc. (PWA) of Huntsville, Ala. USA. It should be appreciated that the system 20 may have more, less, or different components than those schematically illustrated. Although not described in detail, each of the components are coupled to one another via suitable piping to transport a fluid such as water and/or air. This piping may include other suitable components, such as valves, pumps, and reducers of suitable size based on the process criteria. As the system 20 utilizes relatively lower operating pressure, less fatigue damage results as compared to high pressure waterjet systems.

The fluid supply 22, the pump 24 and the motor 30 function to provide a fluid such as water, typically in liquid form, to the ultrasonic transducer 26 and the nozzle 28. Although water such as shop water which need not be chilled or de-ionized is used throughout this detailed description as the fluid, other suitable fluids may be utilized. In addition, the term “fluid” as defined herein includes liquid, gas, vapor, or any combination thereof. That is, although water is described herein as the liquid for mostly environmental and economic reasons, virtually any sprayable liquid such as water-based liquids, conventional cleaning liquids, and others which can be sprayed with sufficient energy will benefit herefrom.

The ultrasonic nozzle 28 may be mounted on a head unit 40 positioned by a computer-controlled X-Y gantry 42 so that the fluid is aimed thereby in response to the control 32 for precision operations. Alternatively, the system 20 may be a mobile unit. It should be understood that various control subsystems and mount arrangements may alternatively or additionally provided. The ultrasonic nozzle 28 includes orifices 44 that have a size and location based upon the water across the swath (water contact area). In one disclosed non-limiting embodiment, the orifice diameter is typically about 0.05 inches (1.27 mm) and the ultrasonic nozzle 28 rotates. The ultrasonic nozzle 28 may have a single orifice that is useful for many applications such as cutting and deburring various materials. However, for applications such as cleaning or de-coating large surface areas, a single orifice only removes a narrow swath per pass. Therefore, for applications such as cleaning and removing coatings or other material it is useful to provide a second embodiment in which the ultrasonic nozzle 28 has a plurality of orifices.

The ultrasonic nozzle 28 may utilize a piezoelectric transducer or a piezomagnetic (magnetostrictive) transducer connected to a microtip, or, “velocity transformer”, to modulate, or pulsate, a continuous-flow waterjet exiting the ultrasonic nozzle 28 which thereby transforms the continuous-flow waterjet into a pulsated waterjet. That is, the ultrasonic transducer 26 may be located within the ultrasonic nozzle 28. The ultrasonic nozzle 28 forms a “forced pulsed waterjet”, or a pulsated waterjet. The pulsated waterjet is a stream, or train, of water packets or water slugs, each imparting a waterhammer pressure on a target surface. Because the waterhammer pressure is significantly greater than the stagnation pressure of a continuous-flow waterjet, the pulsated waterjet is much more efficient at cutting, cleaning, de-burring, de-coating and breaking.

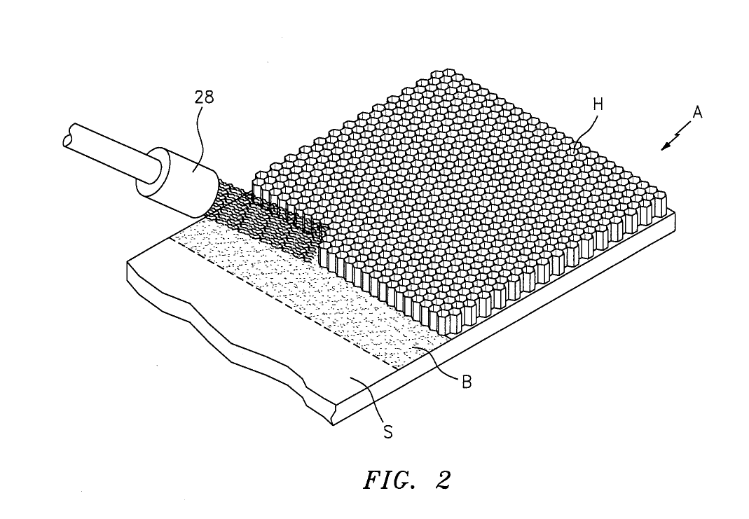

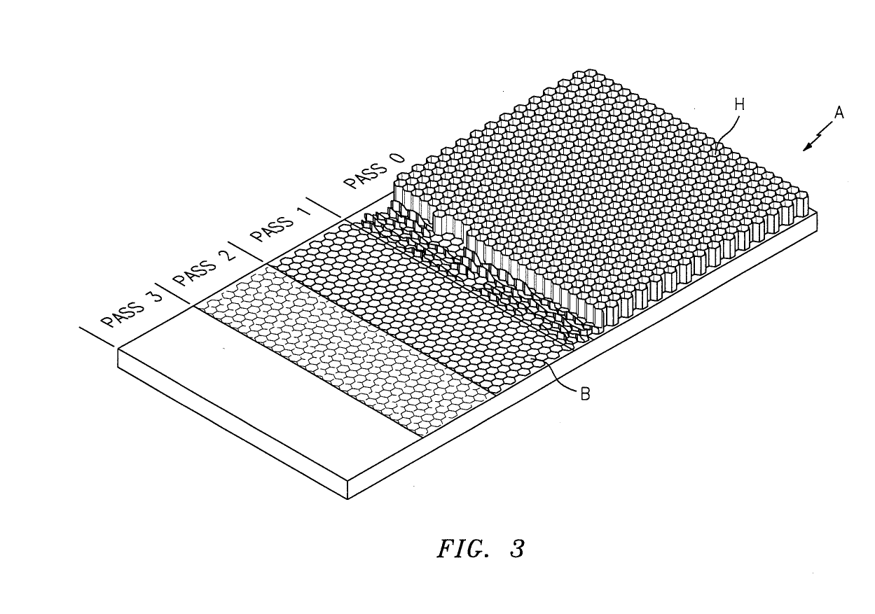

The fluid slugs produce a pulse-wave effect on, for example, an aerospace component A such as an abradable seal to remove honeycomb H and preferably braze B, without damage to the underlying substrate S (see FIG. 2). Generally, the system 20 provides a relatively high frequency of impact at relatively lower pressure with relatively higher volume to provide fracture and erosion mechanics to essentially hammer the honeycomb H and braze B from the underlying substrate S over a number of passes (see FIG. 3).

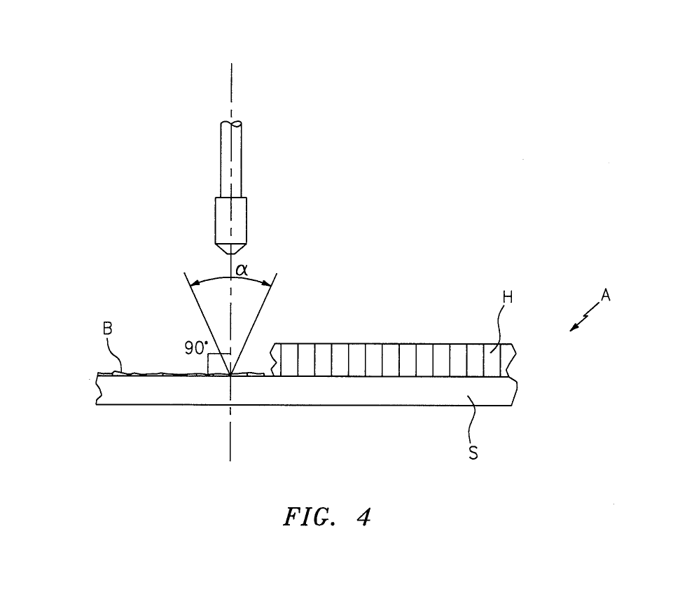

In one disclosed non-limiting embodiment, a process to remove the honeycomb H, and preferably braze B from the substrate S without damage to the underlying substrate S, orients the ultrasonic nozzle 28 at an angle of attack a sufficient to fracture the honeycomb H from the underlying substrate S (see FIG. 4). That is, in contrast to conventional high pressure waterjets which strip or cut the honeycomb, the forced pulse jets of individual fluid slugs from the system 20 essentially hammer the honeycomb H from the underlying substrate S. The angle α is typically about perpendicular, i.e., (90) degrees +/−forty-five (45) degrees with respect to the substrate S. More specifically, angles of attack a especially preferred are ninety (90) degrees +/−twenty (20) degrees with respect to the substrate S. That is, the forced pulse jet strikes the honeycomb H at an angle, separating the honeycomb H from the braze B and/or the braze B from the substrate S.

The stand-off distance from the ultrasonic nozzle 28 to the substrate S according to one disclosed non-limiting embodiment is up to about 12 inches (about 30.48 cm), with up to about 6 inches (about 15.24 cm) preferred, and about 2 inches (about 5.08 cm) to about 4 inches (about 10.16 cm) especially preferred. As the ultrasonic nozzle 28 makes a second pass (see FIG. 3) across the substrate S, it can be oriented such that there is a slight overlap between the first path swath and the second path swath. Typically, the first path swath removes the honeycomb H and the second path swath at least partially removes the braze B (see FIG. 3). It should be appreciated that any number of passes maybe utilized but three (3) is typical for honeycomb H and braze B removal.

The water pressure exiting the ultrasonic nozzle 28 should be sufficient to remove the honeycomb H and preferably the braze B, without damage to the underlying substrate S. Typically, these pressures are about 5,000 psi (about 345 bar) to about 15,000 psi (about 1034 bar) at a volume of about eight to thirteen (8-13) gallons per minute. In one example, an Aluminum honeycomb material is processed at 8 GPM flow rate and 10 Ksi. In another example, a Nickel honeycomb material is processed and 10 GPM flow rate at 15 Ksi. Equipment limitations in these examples provide a maximum flow rate of the 13 GPM at 15 Ksi.

It should be noted that if the relative motion between the ultrasonic nozzle 28 and the substrate S is too great, i.e. nozzle traverse speed, sufficient dwell time may not be provided to break the honeycomb H from the substrate S. Therefore, the speed which the ultrasonic nozzle 28 traverses the surface of the substrates should be sufficient to remove the honeycomb H without damage to the substrate.

This process minimizes substrate loss and allows for removal of the honeycomb H and/or braze B. It eliminates the use of chemicals to dissolve the braze and also permits ready removal from non-consistent, e.g., out of round, substrates.

It should be understood that relative positional terms such as “forward,” “aft,” “upper,” “lower,” “above,” “below,” and the like are with reference to the normal operational attitude and should not be considered otherwise limiting.

It should be understood that like reference numerals identify corresponding or similar elements throughout the several drawings. It should also be understood that although a particular component arrangement is disclosed in the illustrated embodiment, other arrangements will benefit herefrom.

Although particular step sequences are shown, described and claimed, it should be understood that steps may be performed in any order, separated or combined unless otherwise indicated and will still benefit from the present disclosure.

The foregoing description is exemplary rather than defined by the features within. Various non-limiting embodiments are disclosed herein, however, one of ordinary skill in the art would recognize that various modifications and variations in light of the above teachings will fall within the scope of the appended claims. It is therefore to be understood that within the scope of the appended claims, the disclosure may be practiced other than as specifically described. For that reason the appended claims should be studied to determine true scope and content.

What is claimed is:

1. A method for removing honeycomb from a substrate, the method comprising:
directing a forced pulse jet of fluid to remove the honeycomb from the substrate, whereby the substrate may be reused.

2. The method as recited in claim 1, wherein the pressure of the forced pulse jet of fluid is above about 5,000 psi (about 345 bar).

3. The method as recited in claim 2, wherein the forced pulse jet of fluid is provided at a volume of about thirteen (13) gallons per minute.

4. The method as recited in claim 1, wherein the pressure of the forced pulse jet of fluid is between about 5,000 psi (about 345 bar) to about 15,000 psi (about 1034 bar).

5. The method as recited in claim 1, wherein the forced pulse jet of fluid is a non-deionized water.

6. The method as recited in claim 1, wherein the forced pulse jet of fluid is directed at an angle of attack of between about ninety (90) degrees +/−forty-five (45) degrees with respect to the substrate.

7. The method as recited in claim 1, wherein the forced pulse jet of fluid is directed at an angle of attack of about 90 degrees with respect to the substrate.

8. A method for removing honeycomb from a substrate, the method comprising:
directing a forced pulse jet of fluid at an angle of attack of between about ninety (90) degrees +/−forty-five (45) degrees with respect to the substrate, the fluid striking the substrate at the base of the honeycomb to remove the honeycomb from the substrate, whereby the substrate may be reused.

9. The method as recited in claim 8, wherein the forced pulse jet of fluid is directed at an angle of attack of about 90 degrees with respect to the substrate.

10. The method as recited in claim 9, wherein the pressure of the forced pulse jet of fluid is above about 5,000 psi (about 345 bar).

11. The method as recited in claim 10, wherein the forced pulse jet of fluid is provided at a volume of about thirteen (13) gallons per minute.

12. The method as recited in claim 8, wherein the pressure of the forced pulse jet of fluid is between about 5,000 psi (about 345 bar) to about 15,000 psi (about 1034 bar) at a volume of about thirteen (13) gallons per minute.

13. The method as recited in claim 12, wherein the forced pulse jet of fluid is provided at a volume of about thirteen (13) gallons per minute.

14. The method as recited in claim 12, wherein the fluid striking the substrate at the base of the honeycomb operates to at least partially remove braze from the substrate.

15. The method as recited in claim 8, further comprising performing multiple passes.
